(19) United States
(12) Patent Application Publication
(10) Pub. No.: US 2017/0110921 A1
(43) Pub. Date: Apr. 20, 2017

(54) Electric Machine

(71) Applicant: Siemens Aktiengesellschaft, Muenchen (DE)

(72) Inventor: Tabea Arndt, Erlangen (DE)

(73) Assignee: Siemens Aktiengesellschaft, Muenchen (DE)

(21) Appl. No.: 15/127,902

(22) PCT Filed: Mar. 12, 2015
(86) PCT No.: PCT/EP2015/055205

§ 371 Date: Sep. 21, 2016

(30) Foreign Application Priority Data
Mar. 21, 2014 (DE) 10 2014 205 290.4

(51) Int. Cl. H02K 3/02; H02K 7/18

(52) U.S. Cl. CPC H02K 3/02; H02K 7/183; B82Y 30/00

(57) ABSTRACT

An electric machine may include at least one stator and at least one rotor mounted to rotate relative to the stator, the stator and/or the rotor including at least one electrically conductive conductor winding, wherein at least some sections of the at least one electrically conductive conductor winding are formed from nano-scale carbon structures combined into at least one textile structure, or include nano-scale carbon structures combined into at least one textile structure.

### CROSS-REFERENCE TO RELATED APPLICATIONS

This application is a U.S. National Stage Application of International Application No. PCT/EP2015/055205 filed Mar. 12, 2015, which designates the United States of America, and claims priority to DE Application No. 10 2014 205 290.4 filed Mar. 21, 2014, the contents of which are hereby incorporated by reference in their entirety.

### TECHNICAL FIELD

The invention relates to an electric machine comprising at least one stator and at least one rotor which is mounted so as to be rotatable in relation to the stator, wherein the stator and/or the rotor comprise(s) at least one electrically conductive conductor winding.

### BACKGROUND

Electric machines, or electromechanical converters, respectively, are employed in the prior art as electric motors for producing kinetic energy and as generators for producing electric energy.

Respective electric machines as substantial components comprise a stator and a rotor which is mounted so as to be rotatable in relation to the stator. The stator, or the rotor, respectively, comprises electrically conductive conductor windings which are typically formed from metallic materials, in particular from aluminum or copper.

In particular in the case of electric machines that are operated as generators which are employed in installations for harvesting regenerative electric energy, i.e. in particular in wind power plants or hydraulic power plants, high mechanical as well as electro-thermal loadings, in particular in the conductor windings, caused, for example, by variable wind or flow velocities, which limit the performance spectrum of the electric machines arise by virtue of the dynamic or transient operating conditions, respectively, which occur therein.

### SUMMARY

One embodiment provides an electric machine comprising at least one stator, and at least one rotor rotatably mounted relative to the stator, wherein at least one of the stator or the rotor includes at least one electrically conductive conductor winding, wherein the at least one electrically conductive conductor winding is at least partially formed from, or comprises, nanoscale carbon structures combined to form at least one textile structure.

In one embodiment, the nanoscale carbon structures at least in part are gathered to form at least one textile yarn and/or are at least in part gathered to form at least one textile tape.

In one embodiment, at least one textile rope is formed from the at least one textile yarn, in particular the plurality of textile yarns, and/or from the at least one textile tape, in particular the plurality of textile tapes.

In one embodiment, at least one in particular woven-fabric like, warp-knitted fabric like, or knitted-fabric like planar textile body is formed from the at least one textile yarn, in particular the plurality of textile yarns, and/or from the at least one textile tape, in particular the plurality of textile tapes.

In one embodiment, the nanoscale carbon structures that are gathered to form a textile are at least in portions contained in a matrix formed by at least one matrix material.

In one embodiment, the at least one matrix material is a metal or a plastics material, or comprises a metal or a plastics material.

In one embodiment, the nanoscale carbon structures are configured so as to be tubular.

In one embodiment, at least one nanoscale carbon structure and/or at least one textile structure formed from gathered nanoscale carbon structures is/are mechanically pretensioned.

In one embodiment, a plurality of electrically conductive conductor windings are provided, wherein first electrically conductive conductor windings at least in portions are formed from nanoscale carbon structures that are gathered to form a textile structure, or comprise nanoscale carbon structures that are gathered to form a textile structure, and second electrically conductive conductor windings are formed from a metallic material, in particular aluminum or copper.

In one embodiment, the electric machine is configured as a generator, in particular for a wind power plant or a hydraulic power plant, or as an electric motor.

Another embodiment provides a stator for an electric machine as disclosed above, wherein said stator comprises at least one electrically conductive conductor winding which at least in portions is formed from nanoscale carbon structures that are gathered to form at least one textile structure, or comprises nanoscale carbon structures that are gathered to form at least one textile structure.

Another embodiment provides a rotor for an electric machine as disclosed above, wherein said rotor comprises at least one electrically conductive conductor winding which at least in portions is formed from nanoscale carbon structures that are gathered to form at least one textile structure, or comprises nanoscale carbon structures that are gathered to form at least one textile structure.

### BRIEF DESCRIPTION OF THE DRAWINGS

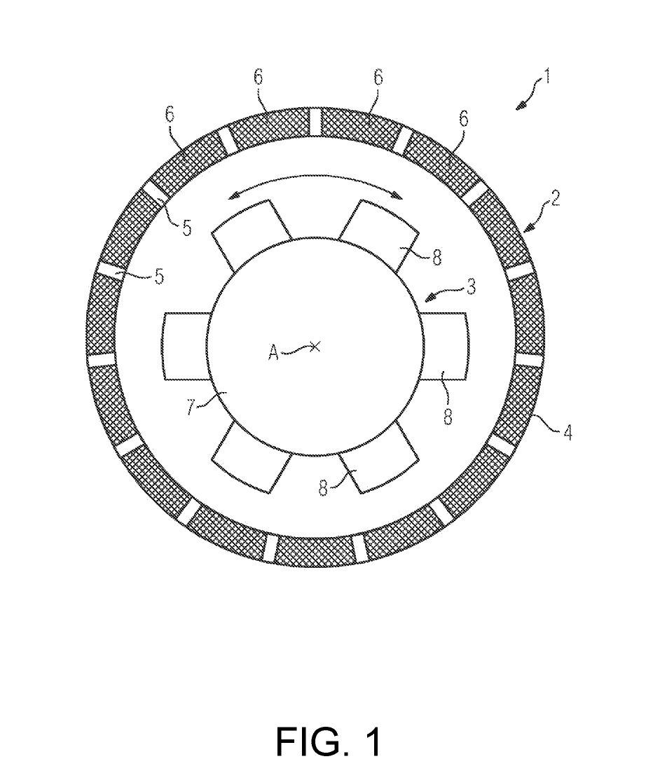

Example aspects and embodiments of the invention are described below with reference to the sole drawing, FIG. 1, which shows an electric machine according to one example embodiment of the invention.

### DETAILED DESCRIPTION

Embodiments of the present invention provide an improved electric machine.

Some embodiments provide an electric machine including at least one stator and at least one rotor mounted to rotate relative to the stator, wherein the at least one electrically conductive conductor winding at least in portions is formed from nanoscale carbon structures that are gathered to form at least one textile structure, or comprises nanoscale carbon structures that are gathered to form at least one textile structure.

One embodiment provides an electric machine comprising at least one stator and at least one rotor which is mounted so as to be rotatable in relation to the at least one stator. The particular configuration of the electrically conductive conductor windings that are associated with one stator and/or one rotor which is mounted so as to be rotatable in relation to the stator is the essential feature of the disclosed electric machine. The electrically conductive conductor windings on the stator side and/or on the rotor side, hereunder in short referred to as conductor windings, are at least in portions formed from nanoscale carbon structures that are gathered to form at least one textile structure. It is also possible that the conductor windings at least in portions comprise nanoscale carbon structures that are gathered to form at least one textile structure.

Thus, the conductor windings on the stator side and/or on the rotor side of the disclosed electric machine have a particular structural construction. A respective conductor winding is thus at least in portions configured as a textile structure that is formed from nanoscale carbon structures, or as a textile that is formed from nanoscale carbon structures, respectively; or a respective conductor winding at least in portions comprises a textile structure that is formed from nanoscale carbon structures, or a textile that is formed from nanoscale carbon structures, respectively.

Nanoscale carbon structures are in particular to be understood to be so-called carbon nanotubes (CNT for short). Consequently, the nanoscale carbon structures are typically present in a tubular shape or in tubular structures, respectively, or are configured as such, respectively.

The term “nanoscale” is indicative of the dimensions, in particular of the diameter or the molecular size of the carbon structures, respectively, which are typically in a range between 1 and 100 nm. It is self-evident that exceptions, in particular in terms of higher values, are possible.

An advantage of respective conductor windings can be seen in that on account of the light weight of nanoscale carbon structures, in particular in comparison to conventional materials for configuring respective conductor windings, and thus of the light weight of respective conductor windings that are formed from said nanoscale carbon structures or comprise the latter, a significant reduction of the mechanical loadings which arise for operational reasons is achievable. This aspect is of significance in particular for electric machines which are employed in dynamic or transient operating conditions, respectively. Electric machines of this type are in particular generators for harvesting electric energy, i.e. as implemented in particular in wind power or hydraulic power plants.

The textile structure of the nanoscale carbon structures, or of respective conductor windings, respectively, moreover enables a significantly higher degree of filamentation of the conductor windings and thus a significantly higher winding density as compared to conventional conductor windings. In this manner, electrical and/or electro-thermal losses which arise for operational reasons may be reduced, and the thermal operating range and thus the performance spectrum of the electric machine may be extended. This aspect in turn is of significance in particular for electric machines which are employed in dynamic or transient operating conditions, respectively.

A further advantage of respective conductor windings is to be seen in that nanoscale carbon structures, in particular in comparison to conventional conductor-winding materials such as, for example, aluminum or copper, display a lower temperature dependence on the electrical resistance. In this manner, higher operating temperatures may be implemented, this in turn extending the thermal operating range and thus the performance spectrum of the electric machine.

A further advantage of respective conductor windings is to be seen in the outstanding mechanical stability of the former which can be traced back to the outstanding mechanical properties of nanoscale carbon structures. In the same way, respective conductor windings are distinguished by an outstanding chemical stability in particular in relation to corrosive environments.

All in all, an improved electric machine is implemented by the use of respective conductor windings that are formed from nanoscale carbon structures that are gathered to form at least one textile structure, or that comprise nanoscale carbon structures that are gathered to form at least one textile structure.

Respective textile structures that are formed from nanoscale carbon structures may be textile yarns or textile tapes, for example. The nanoscale carbon structures thus may be at least in part gathered to form at least one textile yarn. The textile yarns herein may at least in portions be inherently twisted. Alternatively or additionally, the nanoscale carbon structures may at least in part be gathered to form at least one textile tape. Consequently, respective conductor windings may at least in part, in particular entirely, be present as textile yarns or textile tapes, or comprise the latter, respectively.

The nanoscale carbon structures in the variant of the textile yarn typically have rotund cross sections, and in the variant of the textile tape typically have quadrangular, in particular rectangular, cross sections. The cross section of the nanoscale carbon structures, or of a textile structure formed therefrom, respectively, is to be selected in particular with a view to specific application conditions or operating conditions, respectively, of the electric machine.

Further, at least one textile rope may be formed from at least one respective textile yarn, in particular a plurality of textile yarns, and/or from at least one respective textile tape, in particular a plurality of textile tapes. Respective textile yarns or textile tapes may thus be further processed to form textile ropes, this potentially being expedient with a view to specific application conditions or operating conditions, respectively, of the electric machine. Consequently, respective conductor windings may also be present as textile ropes or comprise the latter, respectively.

In the same way, at least one in particular woven-fabric like, warp-knitted fabric like, or knitted-fabric like planar textile body may be formed from at least one respective textile yarn, in particular a plurality of textile yarns, and/or from at least one respective textile tape, in particular a plurality of textile tapes. Respective textile yarns or textile tapes may thus be further processed to form planar textile structures, this potentially being expedient with a view to specific application conditions or operating conditions, respectively, of the electric machine. Consequently, respective conductor windings may also be present as planar textile bodies or comprise the latter, respectively.

In the context of the present invention, the term “carbon structure” is thus at all times to be understood to be a nanoscale carbon structure that is gathered to form at least one textile structure, or to form a textile, respectively. It applies herein that one or a plurality of respective carbon structures may in principle be present as a textile yarn, a textile tape, a textile rope, or a planar textile body.

The carbon structures or a part thereof may at least in portions, in particularly entirely, be embedded or contained, respectively, in a matrix formed by at least one matrix material. The matrix material herein directly surrounds the carbon structures or a part thereof.

Depending on the physio-chemical properties of the matrix material, the matrix may serve various purposes. For example, the matrix may serve as a protection of the carbon structures against, in particular mechanical, loadings. The matrix may also serve for establishing or stabilizing, respectively, a specific arrangement or orientation, respectively, of the carbon structures. It is also possible that the matrix serves for externally electrically isolating the conductor windings. The enumeration is not conclusive.

Both electrically conductive materials as well as electrically isolating materials may be considered as respective matrix materials. In the case of an electrically conductive matrix material, this may be a metal or a metal alloy, for example, wherein reference is made in a purely exemplary manner to aluminum or copper, or respective alloys. In principle, an electrically conductive matrix material may also be a plastics material that by respective compounding, for example, has been configured to be electrically conductive. An electrically isolating matrix material may be a thermosetting or thermoplastic plastics material, for example, wherein reference is made in a purely exemplary manner to thermosetting epoxy resins.

For the purpose of influencing in a targeted manner the electrical or thermal conductivity, respectively, of the carbon structures and thus of respective conductor windings, it may be provided that the nanoscale carbon structures are mechanically pretensioned. Thus, a specific tensile force which typically leads to an increase in the electrical or thermal conductivity, respectively, may bear on the nanoscale carbon structures. The mechanical pretensioning of the nanoscale carbon structures may be implemented by pretensioning the latter prior to gathering the latter to form a textile structure. Consequently, mechanically pretensioned nanoscale carbon structures may have been gathered to form a textile structure. Alternatively, the mechanical pretensioning of the nanoscale carbon structures may be performed only in the state in which the latter have already been gathered to form a textile structure.

Not all conductor windings on the stator side and/or the rotor side have to be formed from respective carbon structures. In the case of a plurality of electrically conductive conductor windings being provided on the stator side and/or on the rotor side, it is thus possible that first conductor windings, or a first group of conductor windings, at least in portions are formed from carbon structures, or comprise carbon structures. By contrast, second conductor windings, or a second group of conductor windings, may be formed from a metallic material, in particular aluminum or copper. In terms of a specific exemplary embodiment of an electric machine this may mean, for example, that conductor windings on the stator side are formed from carbon structures or comprise the latter, and conductor windings on the rotor side are formed from a metal such as, for example, aluminum or copper.

The disclosed electric machine may be configured as a generator of an installation for harvesting electric energy, for example, i.e. in particular for a wind power plant or for a hydraulic power plant. However, it is also possible that the electric machine is configured as an electric motor.

Another embodiment provides a stator for an electric machine as disclosed herein. The stator is thus distinguished in that may comprise at least one electrically conductive conductor winding which at least in portions is formed from nanoscale carbon structures that are gathered to form at least one textile structure, or comprises nanoscale carbon structures that are gathered to form at least one textile structure.

Still another embodiment provides a rotor for an electric machine as disclosed herein. The rotor is thus distinguished in that it may comprise at least one electrically conductive conductor winding which at least in portions is formed from nanoscale carbon structures that are gathered to form at least one textile structure, or comprises nanoscale carbon structures that are gathered to form at least one textile structure.

All explanations in the context of the electric machine according to the invention apply in an analogous manner to the stator according to the invention as well as to the rotor according to the invention.

FIG. 1 shows an example electric machine 1 according to one embodiment of the invention. As can be seen, this is an axial view onto the end side of the electric machine 1. The central axis of the electric machine 1 is referenced with A.

The electric machine 1 is part of an installation for harvesting electric energy such as, for example a wind power or hydraulic power plant (not shown), and is thus operated as an electric generator, i.e. as an electromechanical converter for converting kinetic energy to electric energy. Since the figure is an in-principle illustration of the electric machine 1, only those component parts of the electric machine 1 that are required for visualizing the principle according to the invention are shown and explained.

The electric machine 1 comprises a stator 2 and a complementary rotor 3 which is mounted on a shaft (not shown), for example, so as to be rotatable about the central axis A. The rotatable mounting of the rotor 3 is indicated by the double arrow. The stator 2 and the rotor 3 are disposed so as to be coaxial in relation to the central axis A, wherein the stator 2 surrounds the rotor 3. Self-evidently, a reversed arrangement according to which the rotor 3 surrounds the stator 2 is also possible in principle.

The stator 2 has a main stator body 4, i.e. a so-called stator yoke, which is typically formed from a plurality of sheet-metal plates or plate packs, respectively. The main stator body 4 on the side of the internal circumference is provided with inwardly protruding radial protrusions 5, i.e. so-called stator teeth, electrically conductive conductor windings 6 being disposed therebetween on the stator side. The number, orientation, and electric wiring of the conductor windings 6 that are received between the respective protrusions 5 on the stator side are determined in particular by the number of electric poles of the electric machine 1.

The rotor 3 has a main rotor body 7, i.e. a so-called rotor yoke. The main rotor body 7 on the side of the external circumference is provided with magnetic elements 8 which are typically permanently magnetic, i.e. based on a neodymium compound, for example. This applies in particular to so-called permanently excited electric machines 1. In the case of so-called electrically excited electric machines 1, the magnetic elements 8 are replaced by respective coil packs from the conductor material, the poles being formed in this way. The conductor windings 6 on the stator side are formed from nanoscale carbon structures that are gathered to form textile structures and that are thus present as textiles.

The nanoscale carbon structures that are gathered to form textile structures are so-called carbon nanotubes, that is to say tubular carbon structures.

The textile structures are in particular textile yarns or textile tapes. Textile ropes may furthermore be formed from the textile yarns or textile tapes. It is also possible that planar textile bodies, i.e. woven fabrics, warp-knitted fabrics, or knitted fabrics are formed from the respective textile yarns or textile tapes, for example.

The nanoscale carbon structures, or a part thereof, or respective textile structures that are formed therefrom, may be mechanically pretensioned, this typically having a positive effect on the electrical and thermal conductivity of said structures and to this extent being potentially expedient.

The configuration of the conductor windings 6 from nanoscale carbon structures that are gathered to form textile structures, in particular with a view to the specific application conditions or operational conditions, respectively, of the electric machine 1, provides a series of advantages which extend and thus positively influence the operational range and the performance spectrum of the electric machine 1. This based in particular on the fact that the conductor windings 6 on the stator side, and thus the entire electric machine 1, are capable of higher loadings in both mechanical and thermal terms as compared to conventional electric machines having conductor windings formed from aluminum or copper, without risking a damage-related failure. Besides, the conductor windings 6 on the stator side, and thus the stator 1 or the electric machine 1, respectively, caused by the comparatively minor density of respective carbon structures, are lighter as compared to conventional electric machines having conductor windings that are formed from aluminum or copper.

The carbon structures, or a part thereof, that are/is gathered to form textile structures, may be embedded in a matrix material forming a matrix, that is to say directly surrounded by a matrix material. The matrix material may be an electrically conductive, metallic matrix material such as aluminum or copper, or an electrically isolating matrix material, a thermoplastic or thermosetting plastics material such as an epoxy resin. Depending on the physio-chemical properties of the matrix material, the matrix may serve various purposes. This includes a mechanical stabilization and/or an external electrical isolation of the conductor windings 6 for example.

While only conductor windings 6 on the stator side are mentioned in the context of the exemplary embodiment of the electric machine 1 as shown in the figure, it is self-evidently also possible that only the rotor 3, or the main rotor body 7, respectively, is provided instead of the stator 2 with respective conductor windings 6. It is also possible that both the stator 2 as well as the rotor 3, or the main rotor body 5, respectively, are provided with respective conductor windings 6.

While the invention has been illustrated in detail and been described in more detail by way of the preferred exemplary embodiment, the invention is not limited by the disclosed examples, and other variations may be derived therefrom by a person skilled in the art without departing from the scope of protection of the invention.

What is claimed is:

1. An electric machine comprising:
at least one stator, and
at least one rotor rotatably mounted relative to the stator,
wherein at least one of the stator or the rotor includes at least one electrically conductive conductor winding,
wherein the at least one electrically conductive conductor winding is at least partially formed from, or comprises, nanoscale carbon structures combined to form at least one textile structure.

2. The electric machine of claim 1, wherein the nanoscale carbon structures at least in part are combined to form at least one textile yarn and/or at least one textile tape.

3. The electric machine of claim 2, wherein at least one textile rope is formed a plurality of textile yarns and/or a plurality of textile tapes.

4. The electric machine of claim 2, comprising at least one woven-fabric like, warp-knitted fabric like, or knitted-fabric like planar textile formed from the at least one textile yarn and/or the at least one textile tape.

5. The electric machine of claim 1, wherein the nanoscale carbon structures combined to form a textile are at least partially contained in a matrix formed by at least one matrix material.

6. The electric machine of claim 5, wherein the at least one matrix material comprises a metal or a plastics material.

7. The electric machine of claim 1, wherein the nanoscale carbon structures are configured so as to be tubular.

8. The electric machine of claim 1, wherein at least one nanoscale carbon structure and/or at least one textile structure formed from combined nanoscale carbon structures is mechanically pretensioned.

9. The electric machine of claim 1, comprising a plurality of electrically conductive conductor windings including:
first electrically conductive conductor windings at least partially formed from, or comprising, nanoscale carbon structures combined to form a textile structure, and
second electrically conductive conductor windings formed from a metallic material.

10. The electric machine of claim 1, wherein the electric machine is configured as a generator for a wind power plant or a hydraulic power plant, or as an electric motor.

11. A stator for an electric machine comprising the stator and a rotatably mounted rotor, the stator comprising:
at least one electrically conductive conductor winding at least partially formed from, or comprising, nanoscale carbon structures combined to form at least one textile structure.

12. A rotor for an electric machine, wherein:
the rotor is rotatably mounted relative to a stator, and
the rotor comprises at least one electrically conductive conductor winding at least partially formed from, or comprising, nanoscale carbon structures combined to form at least one textile structure.

13. The electric machine of claim 9, wherein the second electrically conductive conductor windings are formed from aluminum or copper.
